(19) United States
(12) Patent Application Publication
(10) Pub. No.: US 2012/0300245 A1
(43) Pub. Date: Nov. 29, 2012

(54) INDUCTIVE CHARGING AND DATA TRANSFER BASED UPON MUTUAL DEVICE CAPABILITIES

(76) Inventors: Manjirnath Chatierjee, San Francisco, CA (US); Eric Liu, Santa Clara, CA (US)

(21) Appl. No.: 13/115,818

(22) Filed: May 25, 2011

(51) Int. Cl. G06F 3/12; G06K 15/02

(52) U.S. Cl. 358/1.14; 358/1.15

(57) ABSTRACT

Illustrated is a system and method to use a printer with inductive charging and data exchange capabilities with a mobile computing device to determining the protocol to be used to automatically wirelessly transmit document data to the printer. The system and method includes identifying a mobile computing device that is proximate to a printer with inductive charging and data exchange capabilities, the mobile computing device including document data to be printed. The system and method further includes establishing an inductive link between the mobile computing device and the printer with inductive charging and data exchange capabilities, the inductive link used to establish mutual communication capability. Additionally, the system and method includes selecting the mutual communication capability common to both the mobile computing device and the printer with inductive charging and data transfer capabilities. Further, the system and method includes transmitting the document data using the mutual communication capability.

### CROSS REFERENCE TO RELATED APPLICATIONS

This application is related to U.S. patent application Ser. No. 12/478,766, filed Jun. 4, 2009, entitled INDUCTIVE SIGNAL TRANSFER SYSTEM FOR COMPUTING DEVICES; which is a continuation-in-part of U.S. patent application Ser. No. 12/239,656, filed Sep. 26, 2808, entitled ORIENTATION AND PRESENCE DETECTION FOR USE IN CONFIGURING OPERATIONS OF COMPUTING DEVICES IN DOCKED ENVIRONMENTS, which claims benefit of priority to the following applications: Provisional U.S. Patent Application No. 61/142,560, filed Jan. 5, 2009, entitled ELECTRICAL APPARATUS FOR REAL TIME WIRELESS POWER DELIVERY; Provisional U.S. Patent Application No. 61/142,194, filed Dec. 31, 2808, entitled PROTOCOL FOR REAL TIME POWER AND ACCESSORY DATA CONNECTION; Provisional U.S. Patent Application No. 61/142,195, filed Jan. 1, 2009, entitled TECHNIQUES FOR MAGNETICALLY COUPLING CHARGING CIRCUITS AND DEVICES; Provisional U.S. Patent Application No. 61/142,602, filed Jan. 5, 2009, entitled MAGNETIC CLASP WITH MULTIPLE ORIENTATIONS AND ORIENTATION DETECTION; all of the aforementioned priority applications being hereby incorporated by reference in their entirety.

### BACKGROUND

Inductive charging and data exchange between devices allows for recharging and wireless data exchange without the need for physical connections between devices. Inductive charging involves the use of one or more coils on a device sending an electrical charge via induction, and one or more coils on a device receiving this electrical charge via induction. Data exchange between devices that are sending or receiving an electrical charge may be facilitated using any one of a number of protocols including: BLUETOOTH®, Ultra-Wide Band (UWB), Institute of Electrical and Electronics Engineers (IEEE) 802.11, IEEE 802.16, IEEE 802.15, or IEEE 802.20. Data exchange may also be facilitated using a Near Field Communications (NEC) protocol as embodied in the International Organization for Standardization/International Electrotechnical Commission (ISO/IEC) 18092 standard/European Computer Manufacture Association (ECMA)-340 standards or the ISO/IEC 21481/ECMA-352 standards. Further, data exchange may be facilitated using a proprietary protocol operating in the 3-6 MHz range.

### BRIEF DESCRIPTION OF THE DRAWINGS

Some embodiments of the invention are described, by way of example, with respect to the following figures:

FIG. 1A illustrates one example embodiment of a first positional state of the mobile computing device having telephonic functionality.

FIG. 1B illustrates one example embodiment of a second positional state of the mobile computing device having telephonic functionality.

FIG. 2 is a diagram of a system, according to an example embodiment, to use a printer with inductive charging and data exchange capabilities with a mobile computing device determining the protocol to be used to automatically wirelessly transmit the document data to the printer.

FIG. 3 is a diagram of an interface, according to an example embodiment, for the mobile computing device used to persistently maintain an identification value for a printer used to automatically wirelessly transmit document data to the printer.

FIG. 4 is a diagram of an interface, according to an example embodiment, for the mobile computing device used to accept or reject a price point associated with the printing of a document on a printer capable of wireless charging and printing.

FIG. 5 is a diagram of an interface, according to an example embodiment, for a mobile computing device used to print document data in the form of a webpage.

FIG. 6, a block diagram illustrates a architecture, according to an example embodiment, of a mobile computing device enabled to automatically transmit document data wirelessly to the printer for printing.

FIG. 7 is a diagram of a system, according to an example embodiment, to use a printer with inductive charging and data exchange capabilities with a mobile computing device in determining the protocol to be used to automatically wirelessly transmit document data to the printer.

FIG. 8 is a diagram of a system, according to an example embodiment, to use a printer with inductive charging and data exchange capabilities with a mobile computing device in determining the protocol to be used to automatically wirelessly transmit document data to the printer.

FIG. 9 is a flow chat illustrating a method, according to an example embodiment, to use a printer with inductive charging and data exchange capabilities with a mobile computing device in determining the protocol to be used to automatically wirelessly transmit document data to the printer.

FIG. 10 is a flow chart illustrating a method, according to an example embodiment, used to execute the selection logic module that is used to select a mutual communication capability shared between the printer and the mobile computing device.

FIG. 11 is a flow chart illustrating the execution of a print setup logic module, according to an example embodiment, configured to facilitate printing of a document given a series of inputs.

### DETAILED DESCRIPTION

Illustrated is a system and method to use a printer with inductive charging and data exchange capabilities with a mobile computing device to determine the protocol to be used to automatically wirelessly transmit document data to the printer. As used herein, a printer with inductive charging and data exchange capabilities is referenced as a printer. As used herein, a mobile computing device is a cell phone, Personal Digital Assistant (PDA), Smart phone, slate or tablet device with a touch screen interface, netbook, or other suitable device. The printer may have at least three channels for communicating with a mobile computing device: an inductive link used to setting up a session that identifies a mutual communication capability with the mobile communication device, a power channel for providing inductive charging, and a data channel for exchanging data with the mobile computing device. The exchanging of document data may be facilitated using any one of the above referenced protocols.

In some example embodiments, the mobile computing device is physically proximate to the printer such that the three channels can be established between the printer and the mobile device. Physically proximate, as used herein is a range of 0-4 cm of distance between the printer and the mobile computing device. In one example embodiments, the printer and the mobile computing device may even touch resulting in a physical “tap” between the printer and the mobile computing device.

Where the printer and mobile computing device are physically proximate, the mobile computing, device may be authenticated to the printer during the establishment of an inductive link. In some example embodiments, authentication takes the form of an exchange of at least one data packet that includes a description of the protocols supported by the printer during the session, port information on which the printer may receive document data from the mobile computing device, and authentication information (e.g., a hash value, a private key, a public key, a certificate, or a digital signature) to authenticate the mobile computing device to the printer. This authentication information is referred to herein as a security protocol. An example of the structure and content of this at least one data packet is provided in U.S. patent application Ser. No. 12/621,087 filed on Nov. 19, 2009 and titled “Portable Power Supply Device for Mobile Computing Devices” and which is incorporated by reference in its entirety.

In some example embodiments, based upon the mutual communication capabilities of the mobile computing device and the printer a protocol is automatically selected by the mobile computing device. This protocol is used by the communication channel for transferring document data from the mobile computing device to the printer for printing. As used herein mutual communication capabilities one or more of the above mentioned protocols common to both the mobile computing device and the printer. As used herein, automatically selected includes without the intervention of a user in selecting one or more of the above mentioned protocol.

In one example embodiment, by making the mobile computing device physically proximate (e.g., touching) to the printer, the mobile computing device communicates with the printer to share a data packet with identifying information and to set up an alternate, longer range communications profile (e.g., 802.11 or 802.15) without user intervention. The printer may print whatever is currently displayed on the mobile device or whatever the user requests to print from the mobile device such as a file or image stored on the mobile device. Example print options for a document data include:
Print screen: print whatever is on the screen
Print UI resolution photo (assuming, you are in the photos application)
Print webpage (the device could automatically reformat the page for better printing before sending to the printer)
Print current document
Print map again, this would be reformatted to print-size
Print link—the mobile device could send a link (e.g., a Uniform Resource Locator formatted data) to data that needed to be printed.
   The decision regarding what mutual communication capabilities may be utilized may be based upon a identifying a first protocol shared by both the printer and the mobile computing device, or by using a weighted values comparison between the capabilities of the mobile computing device and the printer.

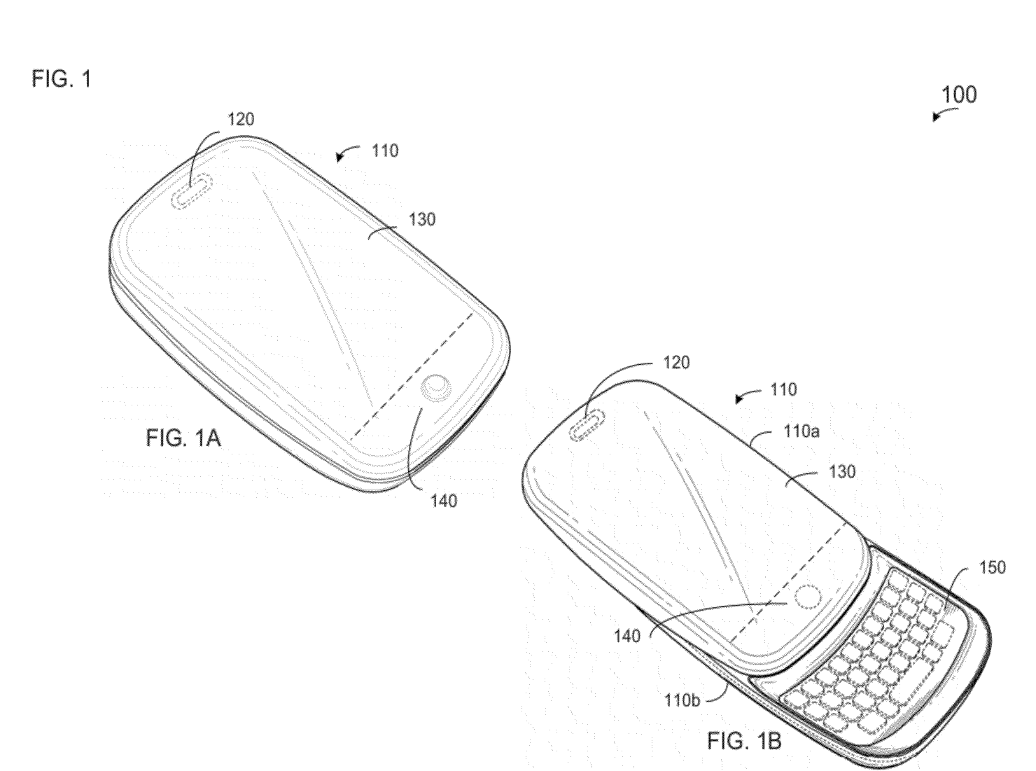

FIGS. 1A and 1B illustrate one embodiment of a mobile computing device 110 that is used to automatically transmit document data along a data channel to a printer capable of inductive charging and wireless data exchange. FIG. 1A illustrates one embodiment of a first positional state of the mobile computing device 110 having telephonic functionality, e.g., a mobile phone or smartphone. FIG. 1B illustrates one embodiment of a second positional state of the mobile computing device 110 having telephonic functionality, e.g., a mobile phone, slate device, smartphone, netbook, or laptop computer. The mobile computing device 110 is configured to host and execute a phone application for placing and receiving telephone calls. In one example embodiment, the configuration as disclosed may be configured for use between a mobile computing device, that may be host device, and an accessory device.

It is noted that for ease of understanding the principles disclosed herein are in an example context of a mobile computing device 110 with telephonic functionality operating in a mobile telecommunications network. However, the principles disclosed herein may be applied in other duplex (or multiplex) telephonic contexts such as devices with telephonic functionality configured to directly interface with Public Switched Telephone Networks (PSTN) and/or data networks having Voice over Internet Protocol (VoIP) functionality. Likewise, the mobile computing device 110 is only by way of example, and the principles of its functionality apply to other computing devices, e.g., desktop computers, slate devices, server computers and the like.

The mobile computing device 110 includes a first portion 110A and a second portion 110B. The first portion 110A comprises a screen for display of information (or data) and may include navigational mechanisms. These aspects of the first portion 110A are further described below. The second portion 110B comprises a keyboard and also is further described below. The first positional state of the mobile computing device 110 may be referred to as an “open” position, in which the first portion 110A of the mobile computing device slides in a first direction exposing the second portion 110B of the mobile computing device 110 (or vice versa in terms of movement). The mobile computing device 110 remains operational in either the first positional state or the second positional state.

The mobile computing device 110 is configured to be of a form factor that is convenient to hold in a user's hand, for example, a Personal Digital Assistant (PDA) or a smart phone form factor. For example, the mobile computing device 110 can have dimensions ranging from 7.5 to 15.5 centimeters in length, 5 to 15 centimeters in width, 0.5 to 2.5 centimeters in thickness and weigh between 50 and 250 grams.

The mobile computing device 110 includes a speaker 120, a screen 130, and an optional navigation area 140 as shown in the first positional state. The mobile computing device 110 also includes a keypad 150, which is exposed in the second positional state. The mobile computing device also includes a microphone (not shown). The mobile computing device 110 also may include one or more switches (not shown). The one or more switches may be buttons, sliders, or rocker switches and can be mechanical or solid state (e.g., touch sensitive solid state switch.).

The screen 130 of the mobile computing device 110 is, for example, a 240×240, a 320×320, a 320×480, or a 640×480 touch sensitive (including gestures) display screen. The screen 130 can be structured from, for example, such as glass, plastic, thin-film or composite material. In one embodiment the screen may be 1.5 inches to 5.5 inches (or 4 centimeters to 14 centimeters) diagonally. The touch sensitive screen may be a transflective crystal display (LCD) screen. In alternative embodiments, the aspect ratios and resolution may be different without departing from the principles of the inventive features disclosed within the description. By way of example, embodiments of the screen 130 comprises an active matrix liquid crystal display (AMLCD), a thin-film transistor liquid crystal display (TFT-LCD), an organic light emitting diode (OLED), an Active-matrix OLED (AMOLED), an interferometric modulator display (IMGD), a liquid crystal display (LCD), or other suitable display device. In an embodiment, the display displays color images. In another embodiment, the screen 130 further comprises a touch-sensitive display (e.g., pressure-sensitive (resistive), electrically sensitive (capacitive), acoustically sensitive (SAW or surface acoustic wave), photo-sensitive (infra-red)) including a digitizer for receiving input data, commands or information from a user. The user may use a stylus, a finger or another suitable input device for data entry, such as selecting from a menu or entering text data.

The optional navigation area 140 is configured to control functions of an application executing in the mobile computing device 110 and visible through the screen 130. For example, the navigation area includes an x-way (x is a numerical integer, e.g., 5) navigation ring that provides cursor control, selection, and similar functionality. In addition, the navigation area may include selection buttons to select functions displayed through a user interface on the screen 130, in addition, the navigation area also may include dedicated function buttons for functions such as, for example, a calendar, a web browser, an e-mail client or a home screen. In this example, the navigation ring may be implemented through mechanical, solid state switches, dials, or a combination thereof. In an alternate embodiment, the navigation area 140 may be configured as a dedicated gesture area, which allows for gesture interaction and control of functions and operations shown through a user interface displayed on the screen 130.

The keypad area 150 may be a numeric keypad (e.g., dialpad) or a numeric keypad integrated with an alpha or alphanumeric keypad or character keypad 150 (e.g., a keyboard with consecutive keys of Q-W-E-R-T-Y, A-Z-E-R-T-Y, or other equivalent set of keys on a keyboard such as a DVORAK keyboard or a double-byte character keyboard).

Although not illustrated, it is noted that the mobile computing device 110 also may include an expansion slot. The expansion slot is configured to receive and support expansion cards (or media cards). Examples of memory or media card form factors include COMPACT FLASH, SD CARD, XD CARD, MEMORY STICK, MULTIMEDIA CARD, SDIO, and the like.

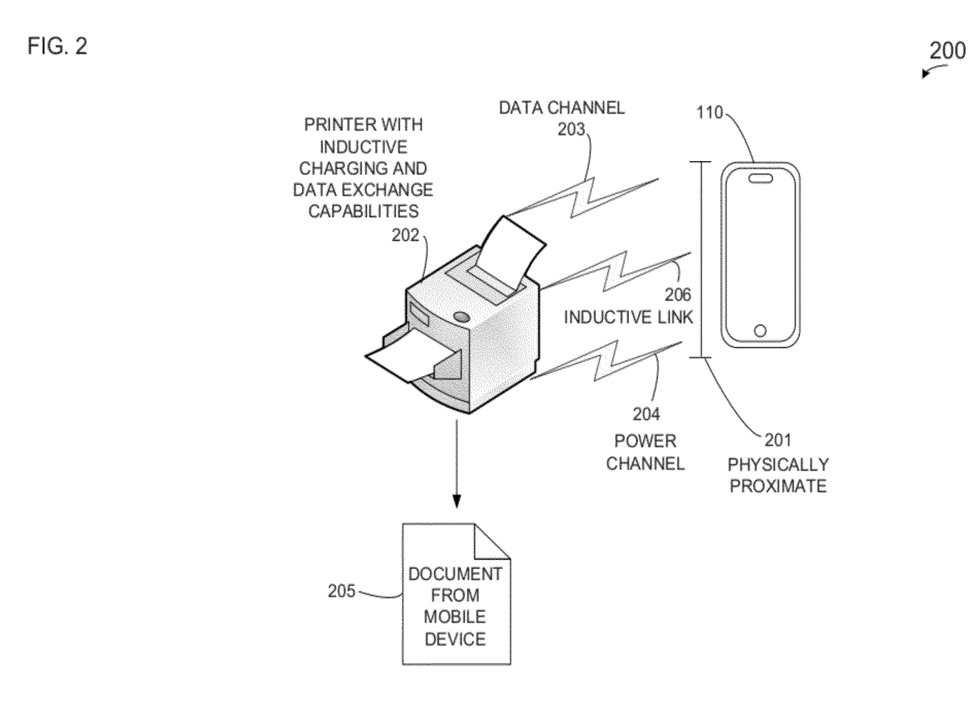

FIG. 2 is a diagram of a system 200 to use a printer with inductive charging and data exchange capabilities with a mobile computing device determining the protocol to be used to automatically wirelessly transmit the document data to the printer. Shown is a mobile computing device 110 that, as denoted at 201, is physically proximate to the printer 202 with inductive charging and wireless data exchange capabilities. An inductive link 206 is established between the mobile computing device 110 and the printer 202, the inductive link 206 used to establish a session between the mobile computing device 110 and the printer 202 for the transmission of document data and/or power. A data channel 203 is set up between the printer 202 and mobile computing device 110 for the transfer of document data. Document data as used herein is a text document (e.g., as a character delimited .txt formatted file, or a .doc formatted file), a photo (e.g., formatted as a Joint Photographic Experts (PEG) document) or image file, a document file, an eXtensible Markup Language (XML) or Hyper Text Markup Language (HTML) based document, a Portable File Document (PDF) document, a post-script or printer file, a URL to a document on a hosted server, or some other suitably formatted document. The document data may be transmitted along the data channel 203 using any one of a number of mutual communication capabilities including: BLUETOOTH®, UWB, WEE 802.11, IEEE 802.16, IEEE 802.15, IEEE 802.20, NFC (e.g., the ISO/IEC 18092 standard, the ECMA 3.40 standard, the ISO/IEC 21481 standard, the ECMA 352 standard), or a proprietary protocol operating in the 3-6 MHz range. A power channel 204 is setup between the mobile computing device 110 and the printer 202 to facilitate the transmission of electrical power via inductive charging. In some example embodiments, document data is exchanged with the printer 202 using the data channel 203 to facilitate the printing by the printer 202 of the document data from the mobile computing device denoted at 205.

In some example embodiments, the system 200 may be used to facilitate three dimensional (3D) model generation. For example, the document data may include a file formatted to support a Computer Aided Design (CAD), or other design schematic. Example file formatting to support CAD or a design schematic includes Microsoft VISIO®, Industry Foundation Classes (IFC), AutoCAD (Drawing Interchange Format, or Drawing Exchange Format) DXF, or a Drawing (DWG) format. The document data is transmitted to a 3D model generation apparatus. This 3D model generation apparatus may use a Stereolithography (SLA) process to generate a 3D model of the apparatus displayed in the document data. This 3D model may be a plastic prototype generated by tracing a laser beam on the surface of a vat of liquid photo-polymer.

In some example embodiments, the printer 202 may reside as part of a print kiosk located in a retail space such that a user of the mobile computing device 110 is charged a fee for using the printer 202. This fee may be based upon the number of pages printed, bandwidth used in printing the document data, the size of the document data in some unit of measurement (e.g., kilobits, megabits, kilobytes, or megabytes) or some other metric. The use of the printer 202 may be tied to an account held (i.e., a “pay per use model”) by a user such that the device ID value “I” for the printer 202 is persistently stored on the mobile computing device 110, and/or the identifier “M” for the mobile device 110 is persistently stored on the printer 202 or database operatively connected to the printer 202. Operatively connected is a physical or logic connection, “I” and “M” are discussed in more detail below. In some example embodiments, a “pay per discrete use” model is implemented where a user pays for each use of the printer 202 and no account for the user is maintained by the printer 202 or database operatively connected to the printer 202. In the “pay per use discrete use” model “I” and/or “M” are not persistently maintained in memory or a database.

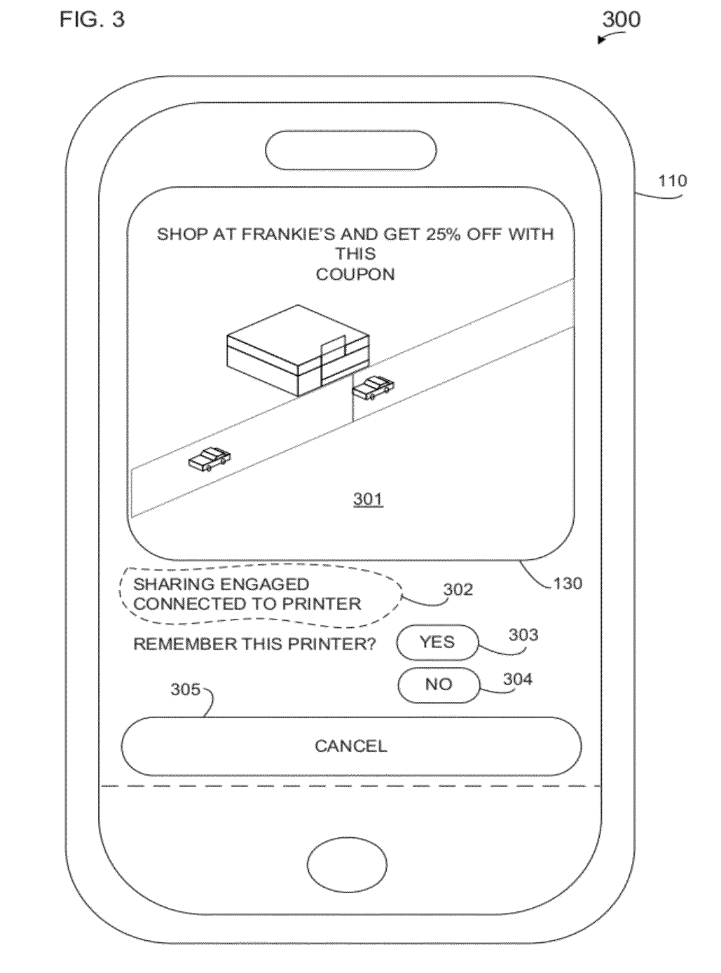

FIG. 3 is a diagram of an interface 300 for the mobile computing device 110 used to persistently maintain an identification value for a printer used to automatically wirelessly transmit document data to the printer. Shown is a mobile computing device 110 with the screen 130. Shown on the screen 130 is a document data 301 in the form of a webpage formatted using XML or HTML. As shown at 302, the mobile computing device 110 is engaged with the printer 202. Engaged as used herein included the selection of the printer 202 where the printer 202 and the mobile computing device are physically proximate and communicating via a mutual communication capability in the form of a protocol. A screen widget 303 and 304 are displayed to allow a user store the identification data for the printer 202 for future use of the printer 202. A screen widget as used herein is a GUI widget, element, text box, radio button, tool bar or other suitable element, Screen widget 305 is executed to allow the session with the printer 202 to be cancelled.

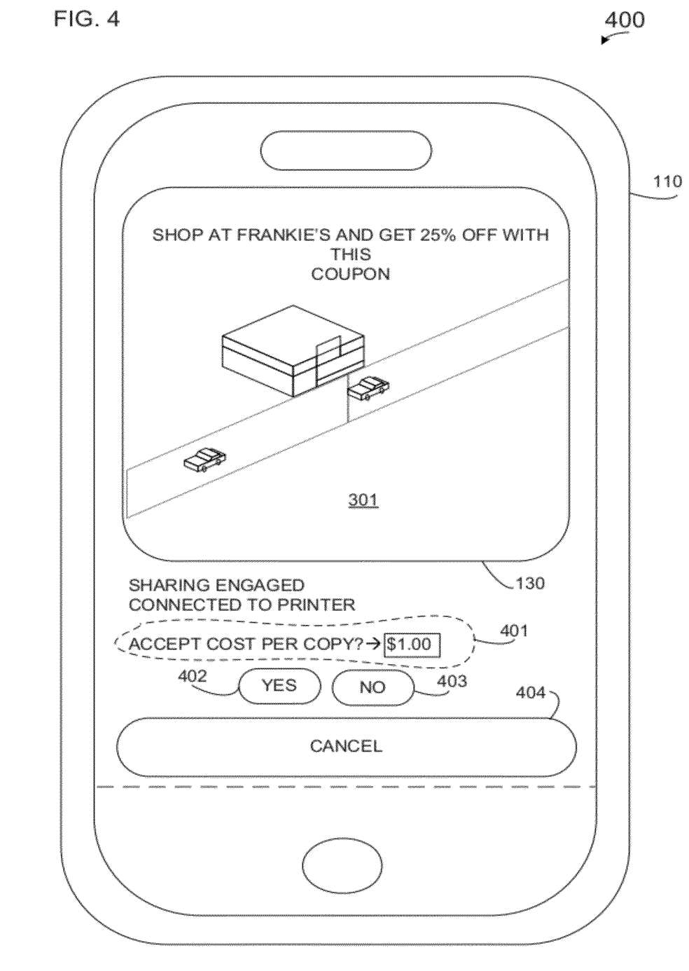

FIG. 4 is a diagram of an interface 400 for the mobile computing device 110 used to accept or reject a price point associated with the printing of a document on a printer capable of wireless charging and printing. Shown is a prompt 401 that shows the cost per copy to print a document. In some example embodiments, a bandwidth cost, a storage cost, or sonic other suitable use cost is displayed. Also shown is a screen widget 402 is used to accept the price point. A screen widget 403 is used to reject price point. A screen widget 404 is used to cancel the transaction.

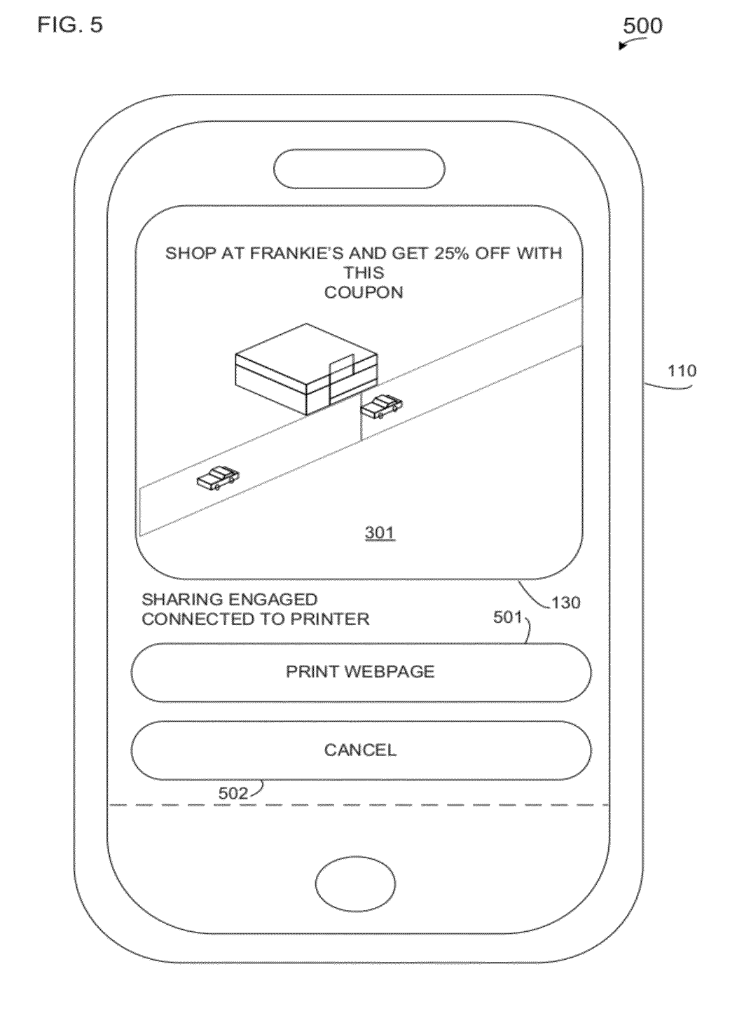

FIG. 5 is a diagram of an interface 500 for a mobile computing device 110 used to print document data in the form of a webpage. Shown is a screen widget 501 used to print a web page. Also shown is a screen widget 502 used to cancel the printing of a web page. In some example embodiments, a document may be stored to the printer 202 for future printing. As referenced above, addition print options may be executed including:
Print screen: print whatever is on the screen
Print full resolution photo (assuming you are in the photos application)
Print webpage (the device could automatically reformat the page for better printing before sending to the printer)
Print current document
Print map—again, this would be reformatted to print-size
Print link the mobile device could send a link (e.g., a Uniform Resource Locator formatted data) to data that needed to be printed.
   Each of these print options may be executed by one or more screen widgets used in conjunction with or in lieu of the screen widget 501.

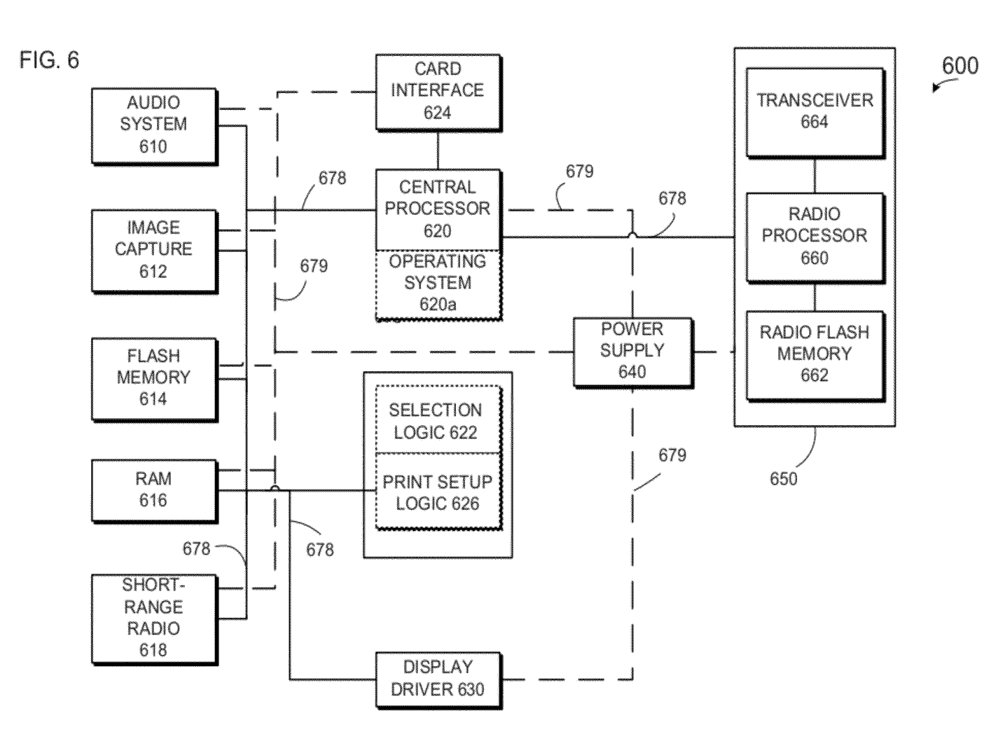

Referring next to FIG. 6, a block diagram illustrates a example architecture of a mobile computing device 110, enabled to automatically transmit document data wirelessly to the printer 202 for printing. By way of example, the architecture illustrated in FIG. 6 will be described with respect to the mobile computing device of FIGS. 1A, and 1B. The mobile computing device 110 includes a central processor 620, a power supply 640, and a radio subsystem 650. Examples of a central processor 620 include processing chips and system based on architectures such as ARM (including cores made by microprocessor manufacturers), ARM XSCALE, QUALCOMM SNAPDRAGON, AMD ATHION, SEMPRON or PHENOM, INTEL ATOM, XSCALE, CELERON, CORE, PENTIUM or ITANIUM, IBM CELL, POWER ARCHITECTURE, SUN SPARC and the like.

The central processor 620 is configured for operation with a computer operating system 620a. The operating system 620a is an interface between hardware and an application, with which a user typically interfaces. The operating system 620a is responsible for the management and coordination of activities and the sharing of resources of the mobile computing device 110. The operating system 620a provides a host environment for applications that are run on the mobile computing device 110. As a host, one of the purposes of an operating system is to handle the details of the operation of the mobile computing device 110. Examples of an operating system include PALM OS and WEBOS, MICROSOFT WINDOWS (including WINDOWS 7, WINDOWS CE, and WINDOWS MOBILE), SYMBIAN OS, RIM BLACKBERRY OS, APPLE OS (including MAC OS and IPHONE OS), GOOGLE ANDROID, and LIN UX.

The central processor 620 communicates with an audio system 610, an image capture subsystem (e.g., camera, video or scanner) 612, flash memory 614, RAM memory 616, and a short range radio module 618 (e.g., Bluetooth, Wireless Fidelity (WiFi) component (e.g., IEEE 802.11, 802.20, 802.15, 802.16)). The central processor 620 communicatively couples these various components or modules through a data line (or bus) 678. The power supply 640 powers the central processor 620, the radio subsystem 650 and a display driver 630 (which may be contact- or inductive-sensitive). The power supply 640 may correspond to a direct current source (e.g., a battery pack, including rechargeable) or an alternating current (AC) source. The power supply 640 powers the various components through a power line (or bus) 679.

The central processor communicates with applications executing within the mobile computing device 110 through the operating system 620a. In addition, intermediary components, for example, a selection logic module 622 and a print setup logic module 626, provide additional communication channels between the central processor 620 and operating system 620 and system components, for example, the display driver 630.

It is noted that in one embodiment, central processor 620 executes logic (e.g., by way of programming, code, or instructions) corresponding to executing applications interfaced through, for example, the navigation area 140 or switches. It is noted that numerous other components and variations are possible to the hardware architecture of the computing device 600, thus an embodiment such as shown by FIG. 6 is just illustrative of one implementation for an embodiment.

In one example embodiment, the print set up logic module 626 is shown that is software (e.g., integrated with the operating system) or firmware (lower level code that resides is a specific memory for that code and for interfacing with specific hardware, e.g., the processor 620). The print set up logic module 626 is configured to facilitate printing of document data given a series of inputs. While pictured on the mobile computing device 110, this print set up logic module 626 may be implemented on either the mobile computing device 110, or the printer 202.

The radio subsystem 650 includes a radio processor 660, a radio memory 662, and a transceiver 664. The transceiver 664 may be two separate components for transmitting and receiving signals or a single component for both transmitting and receiving signals. In either instance, it is referenced as a transceiver 664. The receiver portion of the transceiver 664 communicatively couples with a radio signal input of the device 110, e.g., an antenna, where communication signals are received from an established call (e.g., a connected or on-going call). The received communication signals include voice (or other sound signals) received from the call and processed by the radio processor 660 for output through the speaker 120. The transmitter portion of the transceiver 664 communicatively couples a radio signal output of the device 110, e.g., the antenna, where communication signals are transmitted to an established (e.g., a connected (or coupled) or active) call. The communication signals for transmission include voice, e.g., received through the microphone of the device 110, (or other sound signals) that is processed by the radio processor 660 for transmission through the transmitter of the transceiver 664 to the established call.

In one embodiment, communications using the described radio communications may be over a voice or data network. Examples of voice networks include Global System of Mobile (GSM) communication system, a Code Division, Multiple Access (CDMA system), and a Universal Mobile Telecommunications System (UMTS). Examples of data networks include General Packet Radio Service (ERRS), third-generation (3G) mobile (or greater), High Speed Download Packet Access (HSDPA), High Speed Uplink Packet Access (HSUPA), and Worldwide Interoperability for Microwave Access (WiMAX).

While other components may be provided with the radio subsystem 650, the basic components shown provide the ability for the mobile computing device to perform radio-frequency communications, including telephonic communications. In an embodiment, many, if not all, of the components under the control of the central processor 620 are not required by the radio subsystem 650 when a telephone call is established, e.g., connected or ongoing. The radio processor 660 may communicate with central processor 620 using the data line (or bus) 678.

The card interface 624 is adapted to communicate, wirelessly or wired, with external accessories (or peripherals), for example, media cards inserted into the expansion slot (not shown). The card interface 624 transmits data and/or instructions between the central processor and an accessory, e.g., an expansion card or media card, coupled within the expansion slot. The card interface 624 also transmits control signals from the central processor 620 to the expansion slot to configure the accessory. It is noted that the card interface 624 is described with respect to an expansion card or media card; it also may be structurally configured to couple with other types of external devices for the device 110, for example, an inductive charging station for the power supply 640 or a printing device. The printer 202 is an example of this inductive charging station.

In the foregoing description, numerous details are set forth to provide an understanding of the present invention. However, it will be understood by those skilled in the art that the present invention may be practiced without these details. While the invention has been disclosed with respect to a limited number of embodiments, those skilled in the art will appreciate numerous modifications and variations therefrom. It is intended that the appended claims cover such modifications and variations as fall within the “true” spirit and scope of the invention.

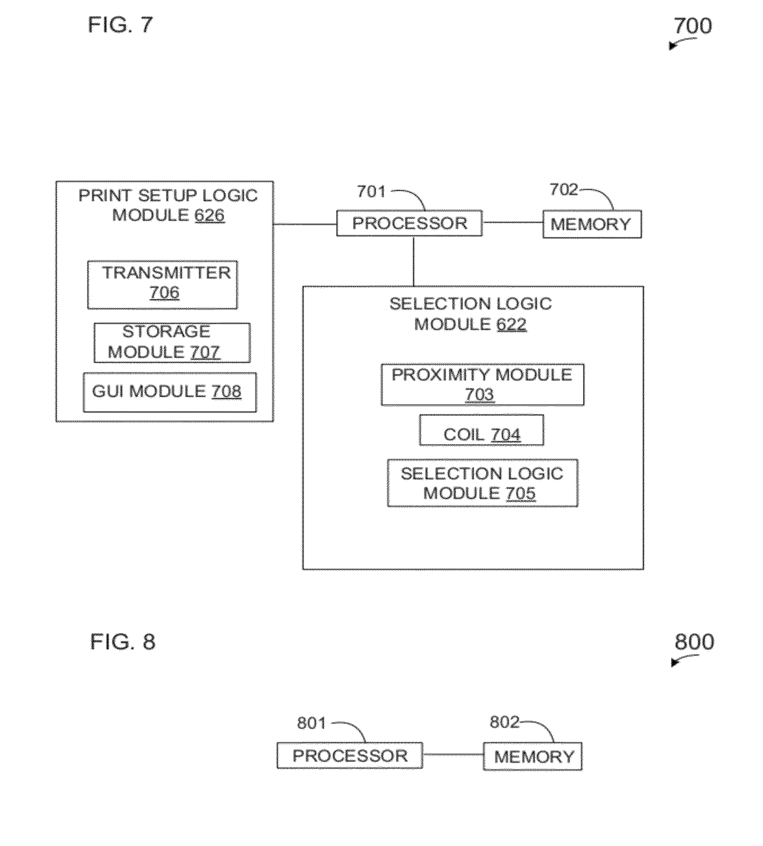

FIG. 7 is a diagram of a system 700 to use a printer with inductive charging and data exchange capabilities with a mobile computing device in determining the protocol to be used to automatically wirelessly transmit document data to the printer. The various blocks shown herein may be implemented in software, hardware, or firmware. These blocks may be operatively connected, where operatively connected includes a physical or logical connection. Shown is a processor 701 operatively connected to a memory 702. Operatively connected to the processor 701 is a selection logic module 622. Included in the logic selection module 622 is a proximity module 703 to identify a mobile computing device that is proximate to a printer with inductive charging and data exchange capabilities, the mobile computing device including document data to be printed. Also included is a coil 704 to establish an inductive link between the mobile computing device and the printer with inductive charging and data exchange capabilities, the inductive link used to establish a mutual communication capability. Further included is a selection logic module 705 to select the mutual communication capability common to both the mobile computing device and the printer with inductive charging and data transfer capabilities. Operatively connected to the processor 701 is the print setup logic module 626. Included in the print set up logic module 626 is a transmitter 706 to transmit the document data using the mutual communication capability. In some example embodiments, proximate is a range of 0-4 cm. In some example embodiments, the mutual communication capability includes at least one of a proprietary data exchange protocol, UWB, BLUETOOTH®, Institute of Electrical and Electronics Engineers (IEEE) 80111, IEEE 802.16, IEEE 802.15, or IEEE 802.20. Included in the print setup logic module 626 is a storage module 707 to persistently storing an identifier for the printer with inductive charging and data exchange capabilities. Also included in the print set up logic module 626 is a GUI module 708 to prompt a user to select a printer for persistent storage of data relating to the mobile computing device.

FIG. 8 is a diagram of an example system 800 to use a printer with inductive charging and data exchange capabilities with a mobile computing device in determining the protocol to be used to automatically wirelessly transmit document data to the printer. This system 800 may be a mobile computing device 110. Shown is a central processor 801 operatively connected to a memory 802. The memory 802 is in communication with the central processor 801, the memory 802 including logic encoded in one or more tangible media for execution and when executed operable to identify a mobile computing device that is proximate to a printer with inductive charging and data exchange capabilities, the mobile computing device including document data to be printed. The logic encoded in one or more tangible media may be further executed to establish an inductive link between the mobile computing device and the printer with inductive charging and data exchange capabilities, the inductive link used to establish a mutual communication capability. The logic encoded in one or more tangible media may further be executed to select the mutual communication capability common to both the mobile computing device and the printer with inductive charging and data transfer capabilities. Additionally, the logic encoded in one or more tangible media may also be executed to transmit the document data using the mutual communication capability. In some example embodiments, proximate is a range of 0-4 cm. In some example embodiments, the mutual communication capability includes at least one of a proprietary data exchange protocol, UWB, BLUETOOTH®, IEEE 802.11, IEEE 802.16, IEEE 802.15, or IEEE 802.20. The logic encoded in one or more tangible media may further be executed to persistently store an identifier for the printer with inductive charging and data exchange capabilities. The logic encoded in one or more tangible media may further be executed to generating a GUI to prompt a user to select a printer for persistent storage of data relating to the mobile computing device.

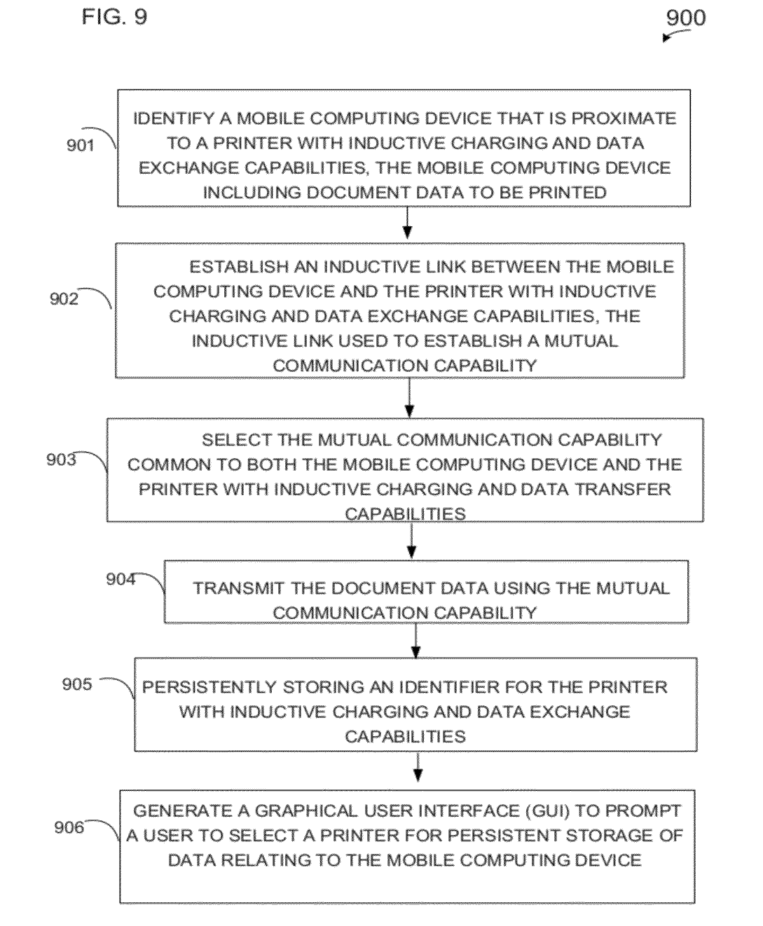

FIG. 9 is a flow chat illustrating a method 900 to use a printer with inductive charging and data exchange capabilities with a mobile computing device in determining the protocol to be used to automatically wirelessly transmit document data to the printer. Operations 901-903 may be executed as part of the selection logic module 622. Operations 904-906 may be executed as part of the print setup logic module 626. Shown is an operation 901 that is executed to identify a mobile computing device that is proximate to a printer with inductive charging and data exchange capabilities, the mobile computing device including document data to be printed. Operation 902 is executed to establish an inductive link between the mobile computing device and the printer with inductive charging and data exchange capabilities, the inductive link used to establish a mutual communication capability. Operation 903 is executed to select the mutual communication capability common to both the mobile computing device and the printer with inductive charging and data transfer capabilities. Operation 904 is executed to transmit the document data using the mutual communication capability. In some example embodiments, the proximate is a range of 0-4 cm. In some example embodiments, the mutual communication capability includes at least one of a proprietary data exchange protocol, UWB, BLUETOOTH®, IEEE 802.11, IEEE 802.16, IEEE 802.15, or IEEE 802.20, Operation 905 is executed to persistently store an identifier for the printer with inductive charging and data exchange capabilities. Operation 906 is executed to generating a GUI to prompt a user to select a printer for persistent storage of data relating to the mobile computing device.

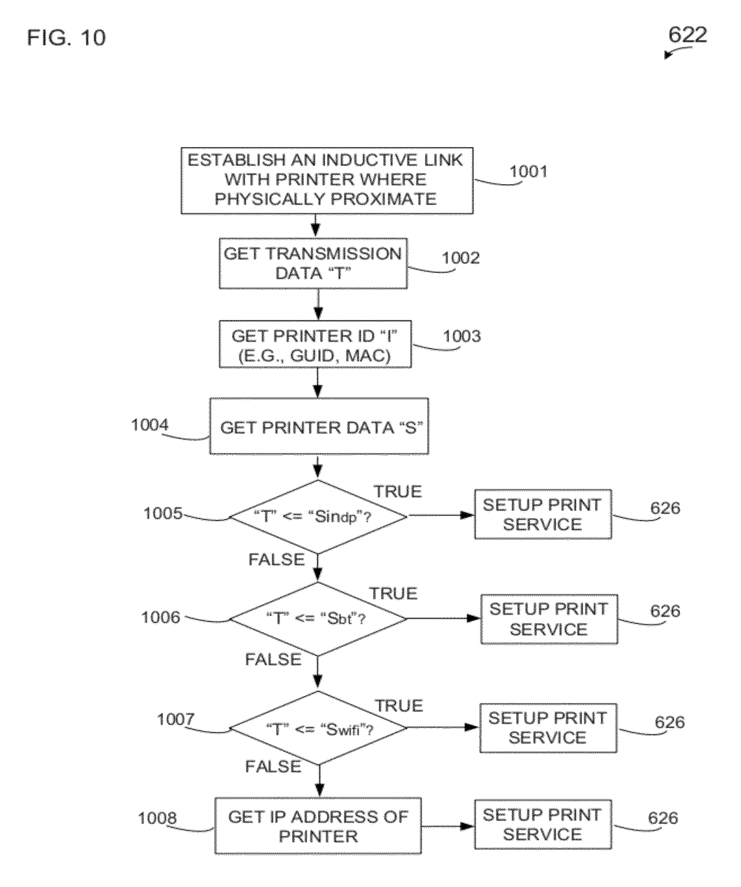

FIG. 10 is a flow chart illustrating an example method used to execute the selection logic module 622 that is used to select a mutual communication capability shared between the printer 202 and the mobile computing device 110. The selection logic module 622 may be executed automatically (i.e., automatically selected) where an inductive link is first established between the mobile computing device 110 and the printer 202. In some example embodiments, the selection logic module 622 determines what mutual communication capabilities exist between the mobile computing device 110 and the printer 202. Where a mutual communication capability is found to exist, this capability (i.e., a protocol) is selected as the basis for the exchange of data between the mobile computing device 110 and the printer 202. As shown in FIG. 10, where more than one mutual communication capability exist weighted values “T” and “S” are calculated. Operation 1001 is executed to establish a session between the mobile computing device 110 and the printer 202 via an inductive link, where the mobile computing device 110 and printer 202 are proximate. The session may be established as part of the establishment of a control plane between the mobile computing device 110 and the printer 202. Additionally, in one example embodiment, the session may be established using a first protocol, but the document data transferred using a second protocol identified using at least one of operations 1002-1008. Operation 1002 is executed to get the transmission data “T”. “T” may be calculated using the following equation:

T=Norm(L)+Norm(units of size of the document*(cost/unit of size))

“L” is the current network latency for an identified protocol (e.g., BLUETOOTH®, IEEE 802.11), and the cost/unit size is the cost per unit size of using the identified protocol. For example, the cost per unit size may be $0.01 per Kbit. The function Norm( ) may act to round the argument value to be an integer value. For example, if “L” is 2 ms, then the Norm (L) would be is 2. Additionally, if the cost is $0.60 (i.e., 1000 Kbit ($0.30/500 Kbit)), then the Norm (0.60) is 6. If the weighted value “T” is large this may mitigate in favor of using one protocol over another, Operation 1002 is executed to get or otherwise retrieve the device ID value “I” for the printer 202, “I” may be a Globally Unique Identifier (GUID), a Media Access Control (MAC) address, an Internet Protocol (IP) address, or other suitable unique numeric identifier for the printer 202. Operation 1004 is executed to get the printer data “S”. “S” may be calculated using the following equation:

S=J+Norm(Bw)

“J” is the current number of print jobs to be performed by the printer 202 using the identified protocol and port associated therewith. “Bw” is the bandwidth associated with the protocol. For example, if a protocol can be used in transmitting at 500 Kbit per second, the result of applying Norm (500 Kbit per second) is 5. In some example embodiments, decision operations 1005-1007 are executed sequentially such that the first operation that satisfies the condition results in the execution of operation 626 and the printing of the document. In some example embodiments, “T” and “S” are calculated for each of the mutual communication capabilities protocols), and a protocol is selected based upon the largest difference between “I” and “S”. For example, if “T” is equal to 8, and the “S” value for the printer 202 using an proprietary data exchange protocol “indp” (referenced as “Sindp”) is 10, and the “S” for BLUETOOTH® (referenced as “Sbt”) is 11, and “S” for wifi (i.e., IEEE 802.11 et seq.) (referenced as “Swifi”) is 15, then “Swift” is selected as to the mutual communication capability to be used. In some example embodiments, UWB, 802.16, 802.15, or 802.20 may be used in lieu of the above mentioned protocols.

In some example embodiments, decision operation 1005 is executed to determine whether “T” is greater than or equal to “Sindp”. Where decision operation 1005 evaluates to “true” the print set up logic module 626 is executed. Where decision operation 1005 evaluates to “false”, the decision operation 1006 is executed. Decision operation 1006 is executed to determine whether “T” is greater than or equal to “Sbt”. Where decision operation 1006 evaluates to “true” the print set up logic module 626 is executed. Where decision operation 1006 evaluates to “false”, the decision operation 1007 is executed. Decision operation 1007 is executed to determine whether “T” is greater than or equal to “Swifi”. Where decision operation 1007 evaluates to “true” the print sot up logic module 626 is executed. Where decision operation 1006 evaluates to “false”, the operation 1008 is executed. Operation 1008 is executed to get the IP address of the printer 202 and to use this IP address to provide the document data to be printed to the print set up logic module 626.

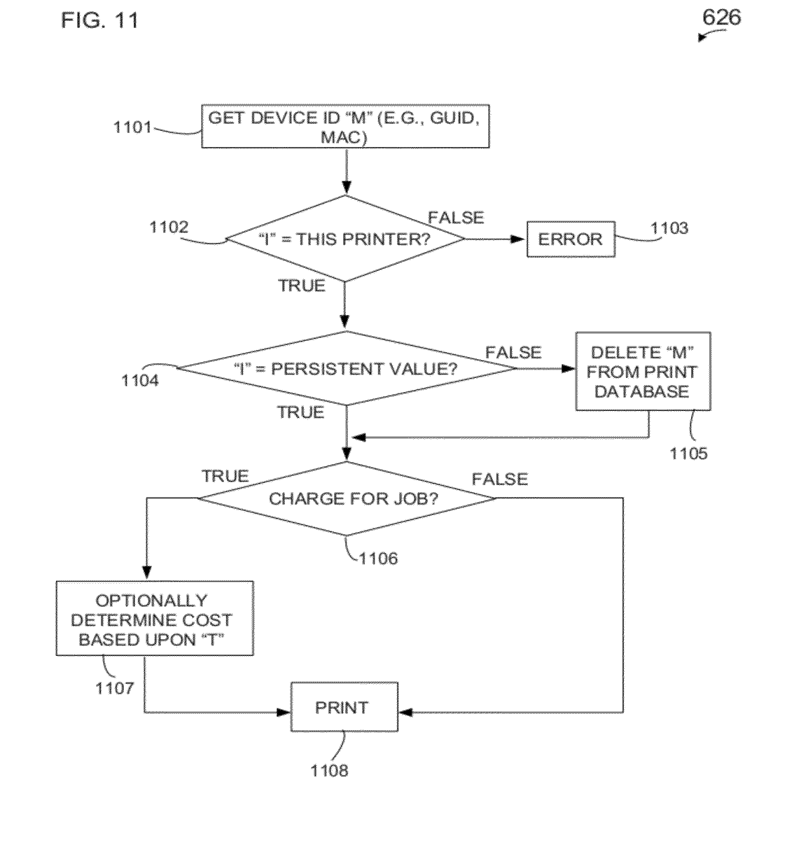

FIG. 11 is a flow chart illustrating the execution of a print setup logic module 626 configured to facilitate printing of document data given a series of inputs. This print setup logic module 626 may be executed on the mobile computing device 110, the printer 202, or divided between the mobile computing device 110 and the printer 202. In some example embodiments, operations 1101-1104 are executed on the mobile computing device 110, while operations 1105-1108 are executed by the printer 202. Shown is an operation 1101 executed to retrieve an identifier “M” for the mobile device 110, this identifier being a GUM, MAC address, or other suitable unique identifier for a mobile computing device 110. Decision operation 1102 is executed to determine whether the printer identifier “I” is for the current printer. In cases where decision operation 1101 evaluates to “false” an error operation 1103 is executed. In cases where decision operation 1101 evaluates to “true” a decision operation 1104 is executed. Decision operation 1104 is executed to determine whether “I” is a persistent value. Persistence may be determined, in part, through the utilization of the interface 300. Persistence may be through the use of a multi-use credential such as a digital certificate, hash value, digital signature, private key, public key or some other suitable credential that is part of the security protocol. In cases where decision operation 1104 evaluates to “false” an operation 1105 is executed to delete “M” from the database for the printer 202. In cases where decision operation 1104 evaluates to “true” “M” is stored to the database for the printer 202 as this “M” value is persistent and will be maintained for future print jobs by the printer 202. Additionally, where the decision operation 1104 evaluates to “true” a decision operation 1106 is executed. Decision operation 1106 is executed to charge for a print job. This change may be based upon bandwidth utilization, pages printed, ink uses or other suitable bases. In cases where decision operation 1106 evaluates to “true” an operation 1107 is executed. In cases where decision operation 1106 evaluates to “false” an operation 1108 is executed, Operation 1107 is executed optionally determine cost based, in part, upon “T”. Operation 1108 is executed to print the document data.

What is claimed is:

1. A computer-implemented method comprising:
identifying a mobile computing device that is proximate to a printer with inductive charging and data exchange capabilities, the mobile computing device including document data to be printed;
establishing an inductive link between the mobile computing device and the printer with inductive charging and data exchange capabilities, the inductive link used to establish a mutual communication capability;
selecting the mutual communication capability common to both the mobile computing device and the printer with inductive charging and data transfer capabilities; and
transmitting the document data using the mutual communication capability.

2. The computer-implemented method of claim 1, wherein proximate is a range of 0-4 cm.

3. The computer-implemented method of claim 1, wherein the mutual communication capability includes at least one of a proprietary data exchange protocol, Ultra-Wide Band (UWB), BLUETOOTH®, an International Organization for Standardization/International Electrotechnical Commission (ISO/IEC) 18092 standard, a European Computer Manufacture Association (ECMA) 340 standard, a ISO/IEC 21481 standard, an ECMA 352 standard, an Institute of Electrical and Electronics Engineers (IEEE) 802.11 protocol, a IEEE 802.16 protocol, an IEEE 802.15 protocol, or an IEEE 802.20 protocol.

4. The computer-implemented method of claim 1, further comprising persistently storing an identifier for the printer with inductive charging and data exchange capabilities.

5. The computer-implemented method of claim 1, further comprising generating a Graphical User Interface (GUI) to prompt a user to select a printer for persistent storage of data relating to the mobile computing device.

6. The computer-implemented method of claim 1, wherein the inductive link includes a security protocol used to set up the mutual communication capability.

7. The computer-implemented method of claim 1, wherein the document data includes at least one of text document data, image data, eXtensible Markup Language (XML) formatted data, Hyper Text Markup Language (HTML) formatted data, post-script formatted data, or URL formatted data.

8. A computer system comprising:
a proximity module to identify a mobile computing device that is proximate to a printer with inductive charging and data exchange capabilities, the mobile computing device including document data to be printed;
a coil to establish an inductive link between the mobile computing device and the printer with inductive charging and data exchange capabilities, the inductive link used to establish a mutual communication capability;
selection logic module to select the mutual communication capability common to both the mobile computing device and the printer with inductive charging and data transfer capabilities; and
a transmitter to transmit the document data using the mutual communication capability.

9. The computer system of claim 8, wherein proximate is a range of 0-4 cm.

10. The computer system of claim 8, wherein the mutual communication capability includes at least one of a proprietary data exchange protocol, Ultra-Wide Band (UWB), BLUETOOTH®, an International Organization for Standardization/International Electrotechnical Commission (ISO/IEC) 18092 standard, a European Computer Manufacture Association (ECMA) 340 standard, a ISO/IEC 21481 standard, an ECMA 352 standard, an Institute of Electrical and Electronics Engineers (IEEE) 802.11 protocol, a IEEE 802.16 protocol, an IEEE 802.15 protocol, or an IEEE 802.20 protocol.

11. The computer system of claim 8, further comprising a storage module to persistently storing an identifier for the printer with inductive charging and data exchange capabilities.

12. The computer system of claim 8, further comprising a Graphical User Interface (GUI) module to prompt a user to select a printer for persistent storage of data relating to the mobile computing device.

13. The computer system of claim 8, wherein the printer with inductive charging and data exchange capabilities is part of a print kiosk where payment is made using at least one of a pay per use model or a pay per discrete use model.

14. A computer system comprising:
at least one processor;
a memory in communication with the at least one processor, the memory including logic encoded in one or more tangible media for execution and when executed operable to:
identify a mobile computing device that is proximate to a printer with inductive charging and data exchange capabilities, the mobile computing device including document data to be printed;
establish an inductive link between the mobile computing device and the printer with inductive charging and data exchange capabilities, the inductive link used to establish mutual communication capability;
select the mutual communication capability common to both the mobile computing device and the printer with inductive charging and data transfer capabilities; and
transmit the document data using the mutual communication capability.

15. The computer system of claim 14, wherein proximate is a range of 0-4 cm.

16. The computer system of claim 14, wherein the mutual communication capability includes at least one of a proprietary data exchange protocol, Ultra-Wide Band (UWB), BLUETOOTH®, an International Organization for Standardization/International Etectrotechnical Commission (ISO/IEC) 18092 standard, a European Computer Manufacture Association (ECMA) 340 standard, a ISO/IEC 21481 standard, an ECMA 352 standard, an Institute of Electrical and Electronics Engineers (IEEE) 802.11 protocol, a IEEE 802.16 protocol, an IEEE 802.15 protocol, or an IEEE 802.20 protocol.

17. The computer system of claim 14, further comprising logic encoded in one or more tangible media for execution and when executed operable to persistently store an identifier for the printer with inductive charging and data exchange capabilities.

18. The computer system of claim 14, further comprising logic encoded in one or more tangible media for execution and when executed operable to generate a Graphical User Interface (GUI) to prompt a user to select a printer for persistent storage of data relating to the mobile computing device.

19. The computer system of claim 14, wherein the inductive link includes a security protocol used to set up the mutual communication capability.

20. The computer system of claim 14, wherein the document data includes at least one of text document data, image data, eXtensible Markup Language (XML) formatted data, Hyper Text Markup Language (HTML) formatted data, post-script formatted data, or URL formatted data.
